(19) United States
(12) Patent Application Publication
(10) Pub. No.: US 2015/0277096 A1
(43) Pub. Date: Oct. 1, 2015

(54) DISPLAY MAGNIFYING DEVICE

(71) Applicants: Huei-Jen Kuo, Tainan City (TW); Yung-Fa Chou, Kaohsiung City (TW); Ting-Sheng Chen, Hsinchu City (TW)

(72) Inventors: Huei-Jen Kuo, Tainan City (TW); Yung-Fa Chou, Kaohsiung City (TW); Ting-Sheng Chen, Hsinchu City (TW)

(21) Appl. No.: 14/304,987

(22) Filed: Jun. 16, 2014

(30) Foreign Application Priority Data
Mar. 28, 2014 (TW) 103205451

(51) Int. Cl. G02B 25/00

(52) U.S. Cl. CPC G02B 25/005

(57) ABSTRACT

A display magnifying device adapted for an electronic device having one or more external sockets is provided. The display magnifying device includes a magnifying glass, a plug, and a stand. The plug fits the external socket. The stand has a first end connected to the magnifying glass and a second end connected to the plug. The display magnifying device is adapted to be detachably assembled to the electronic device by connecting the plug to the external socket. A display magnifying device including a magnifying glass, a casing and a stand is further provided. The casing at least covers a part of the electronic device. The stand has a first end connected to the magnifying glass and a second end connected to the casing. The display magnifying device is adapted to be detachably assembled to the electronic device by covering the part of the electronic device with the casing.

### CROSS-REFERENCE TO RELATED APPLICATION

This application claims the priority benefit of Taiwan application serial no. 103205451, filed on Mar. 28, 2014. The entirety of the above-mentioned patent application is hereby incorporated by reference herein and made a part of this specification.

### BACKGROUND

1. Field of the Invention

The disclosure relates to a magnifying device, and more particularly, relates to a display magnifying device.

2. Description of Related Art

With rapid progress of electronic technologies, electronic devices have been developed to be lighter and slimmer for users to carry around easily. Small-size electronic devices (e.g., mobiles phones, tablet computers, etc.) are now capable of processing many demands of users, such as browsing web pages, downloading data, watching video and so on, and even capable of replacing large-size electronic devices (e.g., desktop computers, etc.) in some cases.

However, as restricted by size, the small-size electronic devices include relatively smaller displays as compared to those of the desktop computers and televisions, which results in problem that it is more difficult for the users to clearly view images on the displays.

### SUMMARY

The disclosure is directed to a display magnifying device, capable of providing users with magnified and being detachably and stably disposed on an electronic device.

The disclosure provides a display magnifying device, adapted for an electronic device. The electronic device has one or more external sockets, and the display magnifying device includes a magnifying glass, a plug, and a stand. The plug fits at least one of the external sockets. The stand has a first end connected to the magnifying glass and a second end connected to the plug. The display magnifying device is adapted to be detachably assembled to the electronic device by connecting the plug to at least one of the external sockets.

The disclosure provides a display magnifying device, adapted for an electronic device. The display magnifying device includes a magnifying glass, a casing, and a stand. The casing at least covers a part of the electronic device. The stand has a first end connected to the magnifying glass and a second end connected to the casing. The display magnifying device is adapted to be detachably assembled to the electronic device by covering the part of the electronic device with the casing.

The disclosure provides a display magnifying device, adapted for an electronic device. The display magnifying device includes a magnifying glass, an attaching member, and a stand. The attaching member is detachably fixed to the electronic device. The stand has a first end connected to the magnifying glass and a second end connected to the attaching member, and the magnifying glass is adapted to be detachably assembled to the electronic device by the attaching member.

The disclosure provides a display magnifying device, adapted for an electronic device. The electronic device includes a first connecting member. The display magnifying device includes a magnifying glass, a second connecting member, and a stand. The second connecting member is detachably fixed to the first connecting member. The stand has a first end connected to the magnifying glass and a second end connected to the second connecting member, and the display magnifying device is adapted to be assembled to the electronic device by detachably fixing the second connecting member to the first connecting member.

Based on above, the display magnifying device of the disclosure is capable of providing an image magnifying effect through the magnifying glass disposed on the display of the electronic device. Also, the display magnifying device may be stably fixed to the electronic device by connecting the plug to the external socket of the electronic device, or by covering at least a part of the electronic device with the casing, so that it can be used and carried around easily.

In order to make the aforementioned and other features and advantages of the present disclosure more comprehensible, several embodiments accompanied with figures are described in detail below.

### BRIEF DESCRIPTION OF THE DRAWINGS

FIG. 1 is a schematic view of a display magnifying device according to an embodiment of the disclosure.

FIG. 2 and FIG. 3 are schematic views illustrating the electronic device of FIG. 1 before and after the display magnifying device is disposed, respectively.

FIG. 4 is a local schematic view of the display magnifying device of FIG. 1.

FIG. 5 to FIG. 7 are local schematic views of the display magnifying device according to other embodiments of the disclosure.

FIG. 8 to FIG. 12 are schematic views of the plug of the display magnifying device according to other embodiments of the disclosure.

FIG. 13A is a local schematic view of the display magnifying device according to another embodiment of the disclosure.

FIG. 13B is a side view of FIG. 13A.

FIG. 14A is a local schematic view of the display magnifying device according to another embodiment of the disclosure.

FIG. 14B is a side view of FIG. 14A.

FIG. 15 and FIG. 16 are schematic views of the stand of the display magnifying device according to other embodiments of the disclosure.

FIG. 17 is a schematic view of a display magnifying device according to another embodiment of the disclosure.

FIG. 18 is a local side view of the display magnifying device of FIG. 17.

FIG. 19 is a schematic view of a display magnifying device according to another embodiment of the disclosure.

FIG. 20 is a schematic view of a display magnifying device according to another embodiment of the disclosure.

### DESCRIPTION OF THE EMBODIMENTS

In order to allow a user to clearly view images displayed on a display of a small-size electronic device, the disclosure provides a magnifying glass disposed on the display of the electronic device. Also, the magnifying glass may be fixed to the electronic device by, for example, a plug or a casing, so that a display magnifying device may be stably fixed to the electronic device, and may be easier to carry around together with the electronic device. Description regarding the above is provided in detail as follows.

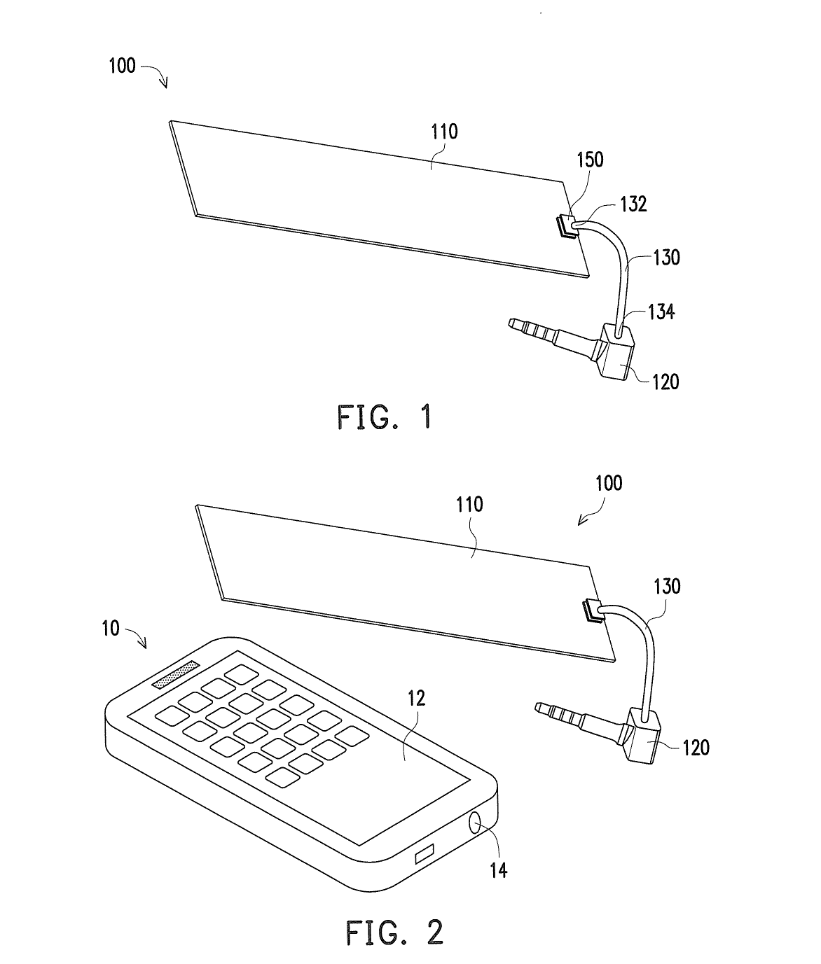

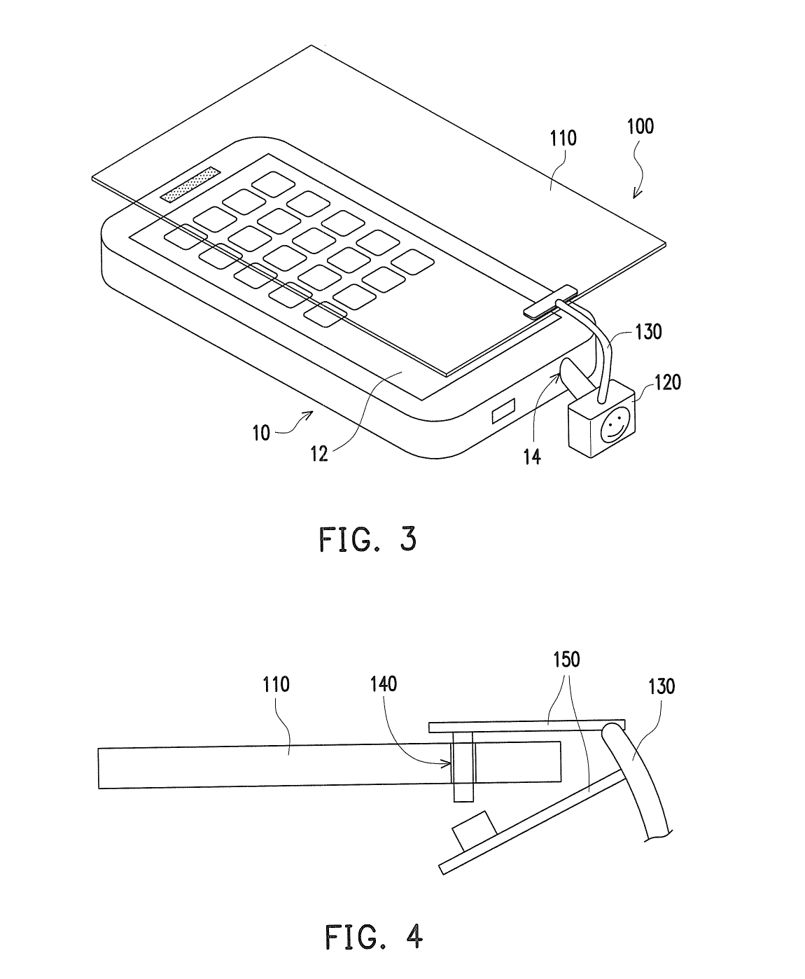

FIG. 1 is a schematic view of a display magnifying device according to an embodiment of the disclosure. FIG. 2 and FIG. 3 are schematic views illustrating the electronic device of FIG. 1 before and after the display magnifying device is disposed, respectively. Referring to FIG. 1 to FIG. 3, a display magnifying device 100 of the present embodiment is adapted for an electronic device 10. In the present embodiment, the electronic device 10 is illustrated as a mobile phone for example. In other embodiments, the electronic device may also be a small-size device such as a tablet computer or a navigation system. As compared to a desktop computer or a television, the electronic device 10 is under restriction of its volume, such that a display 12 may include a smaller size, which results in problem that it is more difficult for some users to clearly view images on the display 12.

Generally, the electronic device 10 includes at least one external socket 14. In the present embodiment, the external socket 14 is illustrated as an earphone hole for example, but a type of the external socket 14 is not limited thereto. In other embodiments, the external socket 14 may also be a micro USB socket, a standard HDMI socket/a mini HDMI socket/a micro HDMI socket, a power supply socket and so on. In case the electronic device 10 is the product of Apple, Inc., the electronic device 14 may be the 30-pin socket or the Lightning socket. Naturally, the external socket 14 may also be a hole on the electronic device 10 without any transmission function, such as a strap hole or a decorative recess, but a type of the external socket 14 is not limited to the above. It is to be noted that, a quantity of the external sockets depicted in FIG. 2 is only illustrative, and practically, the electronic device 10 may include multiple external sockets 14 which are identical to or different from one another.

As shown in FIG. 1, the display magnifying device 100 includes a magnifying glass 110, a plug 120, and a stand 130. In the present embodiment, the magnifying glass 110 may be a convex lens or the Fresnel lens. The plug 120 fits the external socket 14. The stand 130 has a first end 132 connected to the magnifying glass 110 and a second end 134 connected to the plug 120. In the present embodiment, the stand 130 is a stand made of a soft metal, which is flexible, capable of being bent by the user for adjusting an angle and a distance between the magnifying glass 100 and the display 12 of the electronic device 100, and including a specific supporting force. Naturally, in other embodiments, the stand 130 may also be a stand made of plastic or metal which is not flexible, and a type of the stand 130 is not limited thereto as long as a supporting effect of the magnifying glass 110 may be achieved.

As shown in FIG. 3, when the user intends to dispose the display magnifying device 100 on the electronic device 10, it may be fixed to the electronic device 10 simply by connecting the plug 120 of the display magnifying device 100 to the external socket 14 of the electronic device 10, and the user may adjust the stand 130 to change a position of the magnifying glass 110 relative to the display 12 on demands. Similarly, when the user intends to remove the display magnifying device 100 from the electronic device 10, it can be simply done by pulling the plug 120 of the display magnifying device 100 out of the external socket 14 of the electronic device 10. Further, in order to be more aesthetic or recognizable, a desired pattern or text may be printed, coated, or adhered on the plug 120, as shown in FIG. 3. Further, a shape of the plug 120 is not limited to that provided in the drawing. In an embodiment not illustrated, in order to be more aesthetic or recognizable, the shape of the plug 120 may also be of a special shape (e.g., a shape of a cartoon character).

It is to be noted that, although the stand 130 is directly fixed to the plug 120 (e.g., by direct shaping or bonding) in the present embodiment, in other embodiments, the stand 30 may also be fixed to the plug 120 in a detachable manner in other embodiments. That is, a connection relationship between the stand 130 and the plug 120 is not limited thereto.

FIG. 4 is a local schematic view of the display magnifying device of FIG. 1. Referring to FIG. 1 and FIG. 4 together, in the present embodiment, the display magnifying device 100 further includes a first connecting member 140 and a second connecting member 150 fitting each other. The first connecting member 140 is disposed on the magnifying glass 110, and the second connecting member 150 is disposed on the stand 130. In the present embodiment, the first connecting member includes an aperture, and the second connecting member 150 includes two press-buckle units, wherein one of the press-buckle units is buckled to another one of the press-buckle units after passing through the aperture, so as to fix a position of the stand 130 relative to the magnifying glass 110.

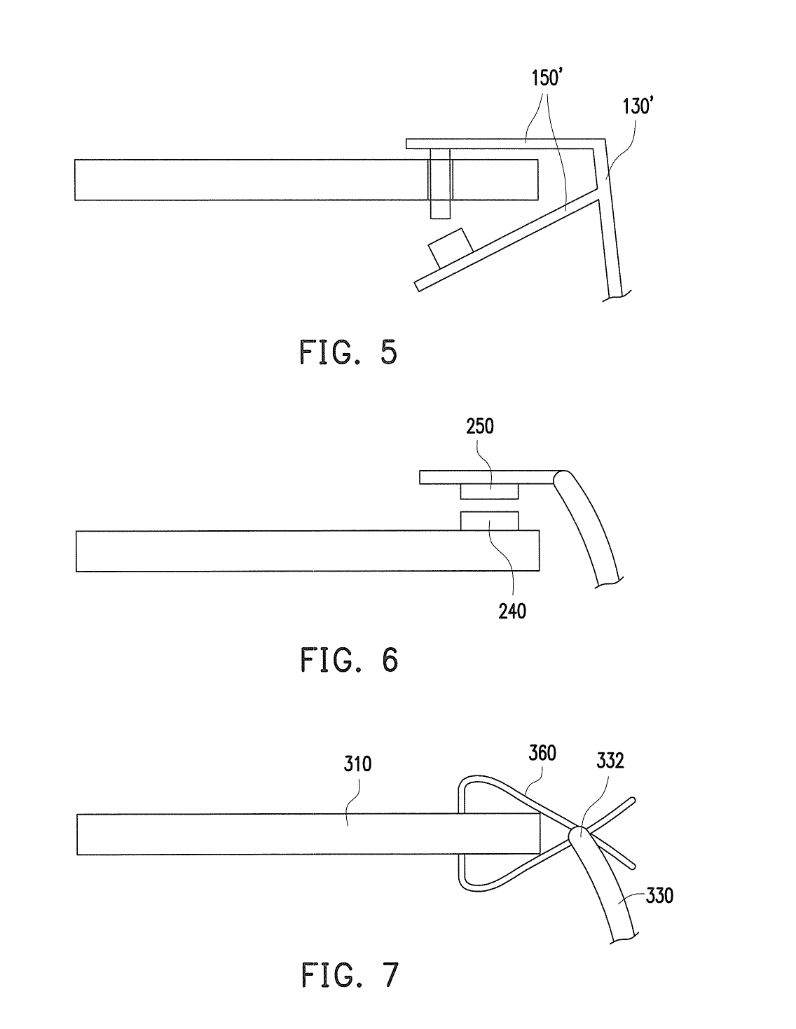

In the present embodiment, the stand 130 and the second connecting member 150 are two different elements. In other embodiments, as shown in FIG. 5, a stand 130′ and a second connecting member 150′ may also be integrated as one. Moreover, in an embodiment not illustrated, the stand may also be formed integrally together with the magnifying glass by, for example, injection molding of plastic.

Naturally, types of the first connecting member 140 and the second connecting member 150 are not limited to the above. FIG. 6 to FIG. 7 are local schematic views of the display magnifying device according to other embodiments of the disclosure. Referring to FIG. 6, a first connecting member 240 and a second connecting member 250 may also include two magnetic units attracting each other. In other embodiments, the first connecting member and second connecting member may also include two corresponding buckling units, two corresponding locking units, or two corresponding bonding units. The stand and the magnifying glass may also be fixed together by using other methods. Referring to FIG. 7, a holder 360 is disposed on a first end 332 of a stand 330 and adapted to hold an edge of a magnifying glass 310, and the stand 330 is connected to the magnifying glass 310 by the holder 360.

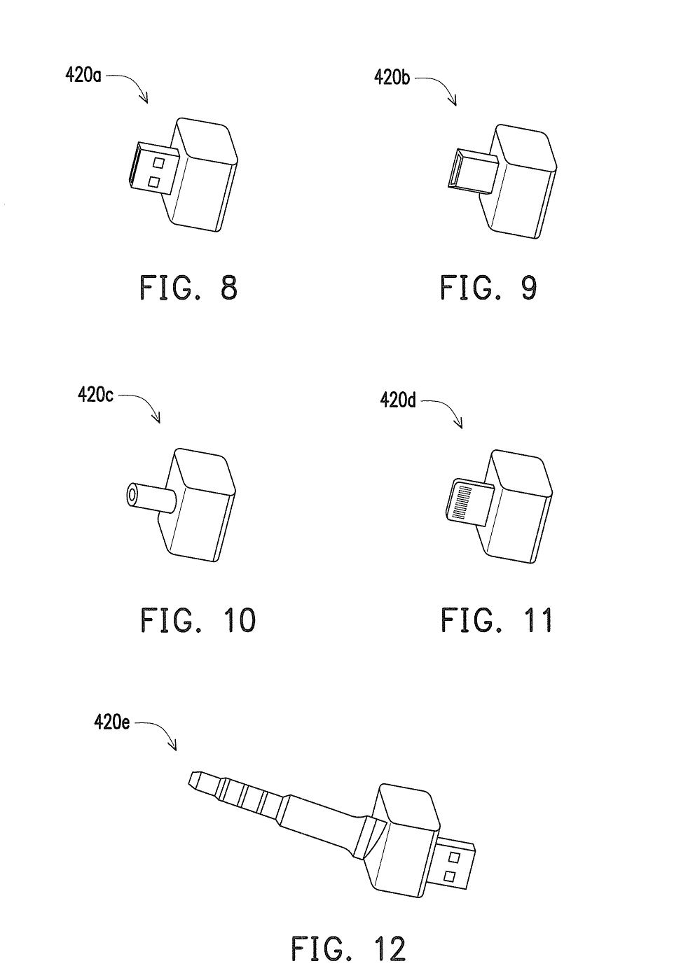

Referring back to FIG. 1, the display magnifying device 100 of the present embodiment is plugged in the external socket 14 originally provided in the electronic device 10, so as to achieve the effect of fixing the display magnifying device to the electronic device 10. Manufacturers may provide various types of the plug for the user to choose from, depending on what types of the external sockets 14 are included in the electronic device 10, and the external socket 14 may also be the power supply terminal or a data transmission terminal other than the audio terminal. FIG. 8 to FIG. 12 are schematic views of the plug of the display magnifying device according to other embodiments of the disclosure. As shown in FIG. 8 to FIG. 10, plugs 420a, 420b and 420c are the micro USB socket, the standard HDMI socket/the mini HDMI socket/the micro HDMI socket, and the power supply socket, respectively. In case the electronic device is the product of Apple, Inc., a plug 420d may also include the Lightning terminal (as shown in FIG. 11), or the 30-pin terminal (not illustrated), but a type of the plug is not limited to the above.

In addition, for allowing the display magnifying device to be applied to more of the electronic devices 10 or allowing the user to use functions provided by the magnifying device of the disclosure and the original terminal at the same time, as shown in FIG. 12, a plug 420e may include two or more sets of terminals with different specifications for providing more choices. Naturally, the two or more sets of terminals with different specifications may be disposed on the same surface of the plug, and the manufacturers may design a corresponding plug for the same surface of the external socket according to model types of hot-selling electronic devices. Take the mobile phone (e.g., iPhone 5) of Apple, Inc. as an example, in which the 3.5 mm earphone hole and the Lightning socket are located on the same surface, thus the manufacturers may design a plug having the audio terminal and the Lightning terminal located on the same surface and spaced apart by a specific distance. Accordingly, when the display magnifying device is disposed on the electronic device, the two terminals may both be inserted into the electronic device for providing more stable fixing effect.

It is noted that, there may only be provided with a physical fixing effect instead of an electrical transmission function in between the plugs 120, 420a, 420b, 420c, 420d, 420e of the display magnifying device and the external socket 14 of the electronic device 10. Accordingly, the manufacturers may selectively use plugs with public regulations on the market, or selectively open a mold for manufacturing the external socket 14 with a contour matching the electronic device 10, as long as the plug is capable of providing the physical fixing effect. Alternatively, there may be provided with both the physical fixing effect and the electrical transmission function at the same time in between the plugs 120, 420a, 420b, 420c, 420d, 420e of the display magnifying device and the external socket 14 of the electronic device 10.

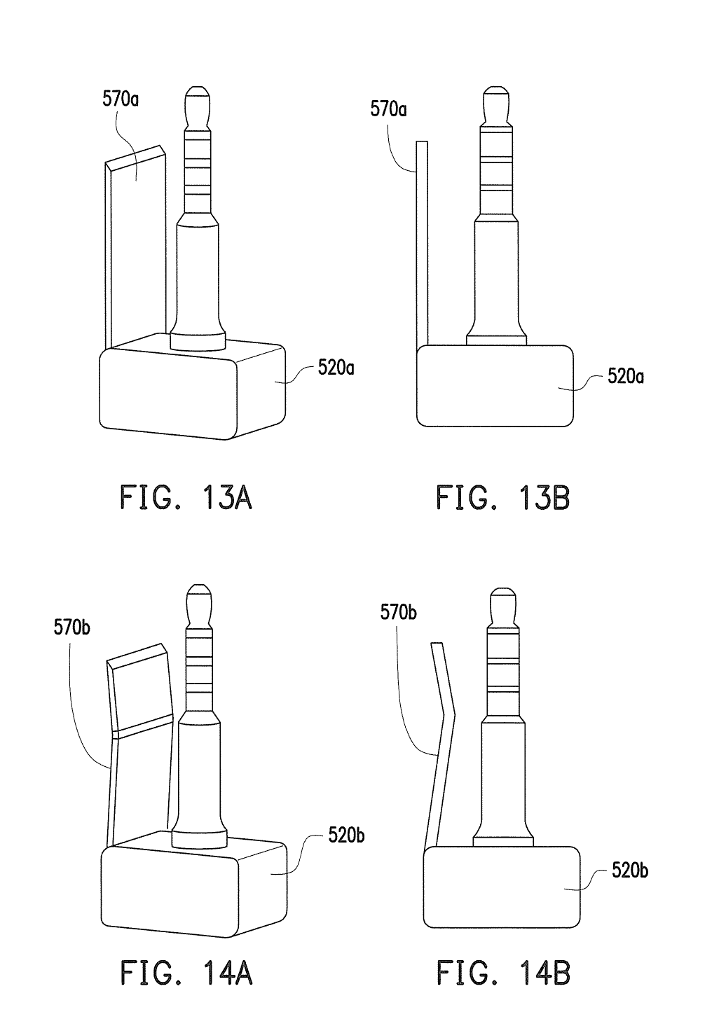

As to further improve the fixing effect between the display magnifying device and the electronic device, FIG. 13A is a local schematic view of the display magnifying device according to another embodiment of the disclosure. FIG. 13B is a side view of FIG. 13A. Referring to FIG. 13A and FIG. 13B, an auxiliary member 570a is disposed on one side of a terminal on a plug 520a. In the present embodiment, the auxiliary member 570a is a bulkhead. When the plug of the display magnifying device is plugged in the external socket of the electronic device, the auxiliary member 570a contacts a surface of the electronic device to improve the fixing effect.

FIG. 14A is a local schematic view of the display magnifying device according to another embodiment of the disclosure. FIG. 14B is a side view of FIG. 14A. Referring to FIG. 14A and FIG. 14B, a major difference between the auxiliary member 570b of the present embodiment and the auxiliary member 570a of the previous embodiment is that, the auxiliary member 570b of the present embodiment includes an inclined section extended along a direction towards a plug 520b. In other words, a shortest distance between the auxiliary member 570b and the plug 520b of the present embodiment is relatively shorter than a shortest distance between the auxiliary member 570a and the plug 520a of the previous embodiment. Accordingly, when the plug of the display magnifying devices is plugged in the external socket of the electronic device, the auxiliary member 570b that is slightly flexible may be opened by a surface of the electronic device to be moved away from the terminal, such that the auxiliary member 570b may be attached more closely to the surface of the electronic device to provide a more preferable fixing effect. Naturally, a type of the auxiliary members 570a and 570b is not limited to the above.

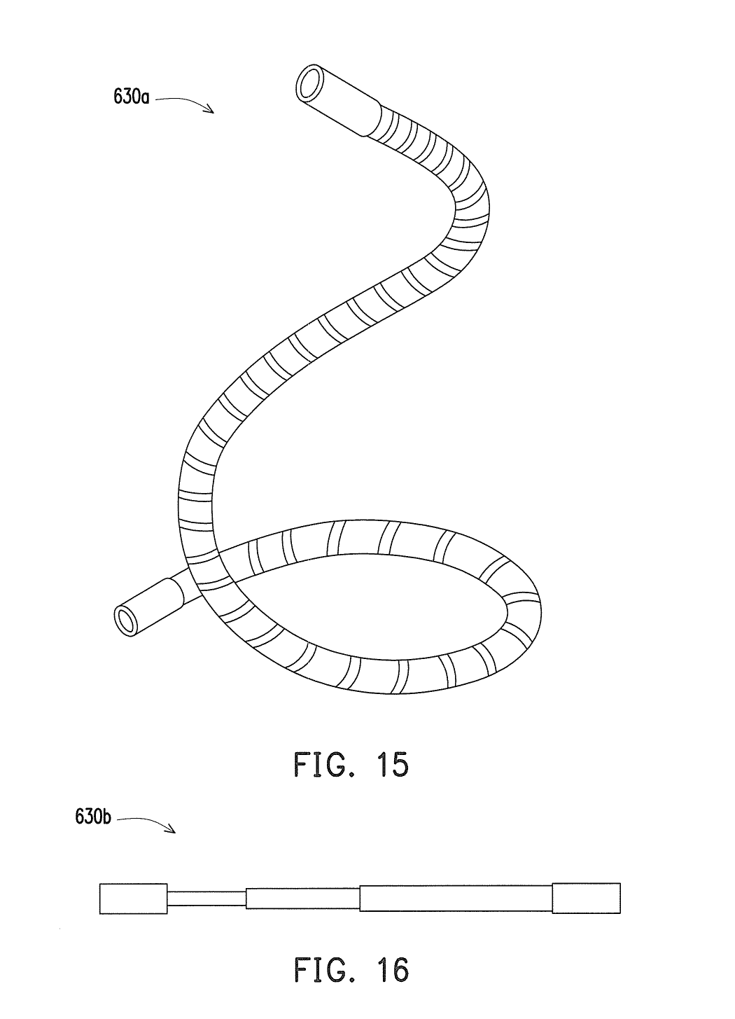

FIG. 15 and FIG. 16 are schematic views of the stand of the display magnifying device according to other embodiments of the disclosure. Referring to FIG. 15 and FIG. 16, stands 630a and 630b are a flexible coil stand and a telescopic stand with adjustable length, respectively, so that the user may adjust an angle and a position of the magnifying glass accordingly.

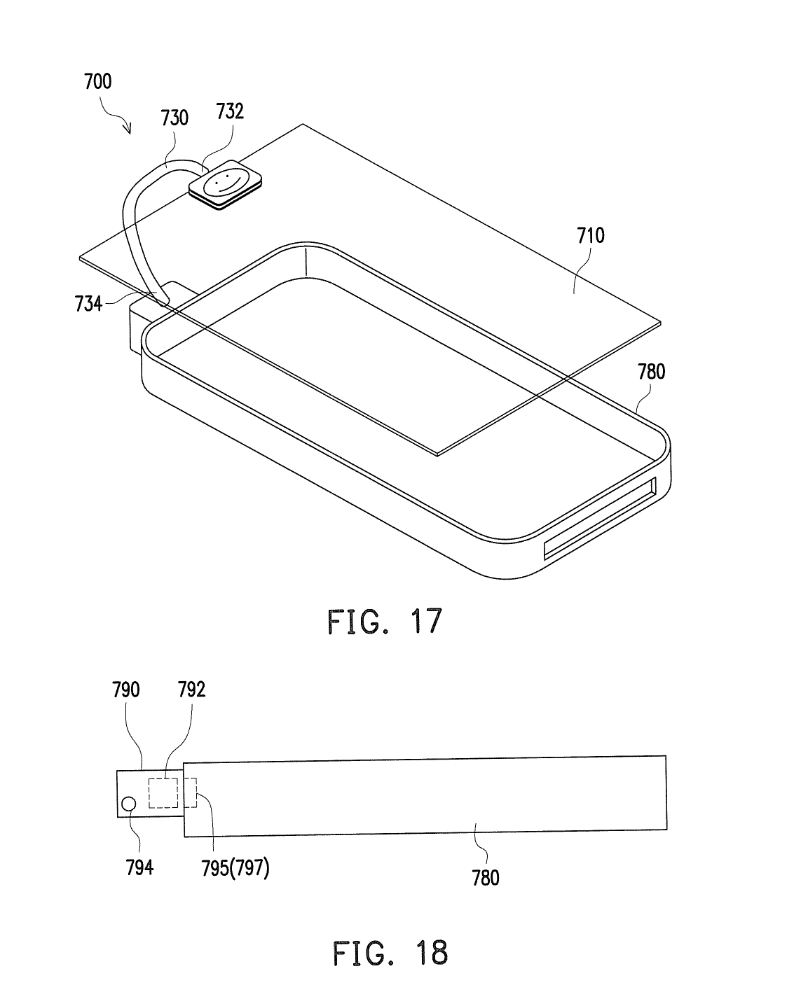

Naturally, the display magnifying device may also be fixed to the electronic device by using other methods. FIG. 17 is a schematic view of a display magnifying device according to another embodiment of the disclosure. Referring to FIG. 17, the display magnifying device 700 of the present embodiment includes a magnifying glass 710, a casing 780, and a stand 730. The casing 780 may at least cover a part of the electronic device (not illustrated, referring to the electronic device 10 in FIG. 2 and FIG. 3). In the present embodiment, the casing 780 may cover five surfaces of the electronic device, so that only a front side of the electronic device is exposed. In other embodiments, the casing 780 may also only cover four side surfaces, fully-covered or portioned-covered, of the electronic device, or magnetically attracted to one surface of the electronic device, as long as it may be fixed to the electronic device. The stand 730 has a first end 732 connected to the magnifying glass 710 and a second end 734 connected to the casing 780.

When the user intends to dispose the display magnifying device 700 on the electronic device, it can be simply done by fixing the casing 780 of the display magnifying device 700 to the electronic device, and the user may adjust the stand 730 to change a distance between the magnifying glass 710 and the display on demands. Similarly, when the user intends to remove the display magnifying device 700 from the electronic device, it can be simply done by removing the casing 780 from the electronic device.

In addition, the magnifying glass 710 and the stand 730 may be fixed by two connecting members fitting each other, or fixed by the holder, and the connecting methods thereof are not repeated hereinafter. Similarly, FIG. 18 is a local side view of the display magnifying device of FIG. 17. Referring to FIG. 18, the stand 730 and the casing 780 may also be fixed together by a third connecting member 790 and a fourth connecting member 795 fitting each other. The third connecting member 790 is disposed on the stand 730, and the fourth connecting member 795 is disposed on the casing 780. In the present embodiment, the third connecting member 790 and the fourth connecting member 795 are two magnetic units 792 and 797 attracting each other, respectively. However, in other embodiments, the third connecting member 790 and the fourth connecting member 795 may also be two corresponding buckling units, two corresponding locking units, or two corresponding bonding units. Alternatively, in other embodiments, the third connecting member 790 and the fourth connecting member 795 may also be fixed together by using the holder.

It is noted that, a desired pattern or text may be printed, coated, or adhered on the connecting member in order to be more aesthetic or recognizable, as shown in FIG. 17. In addition, as shown in FIG. 18, a strap hole 794 may be further disposed on the third connecting member 790 for the user to hang decorative accessories to.

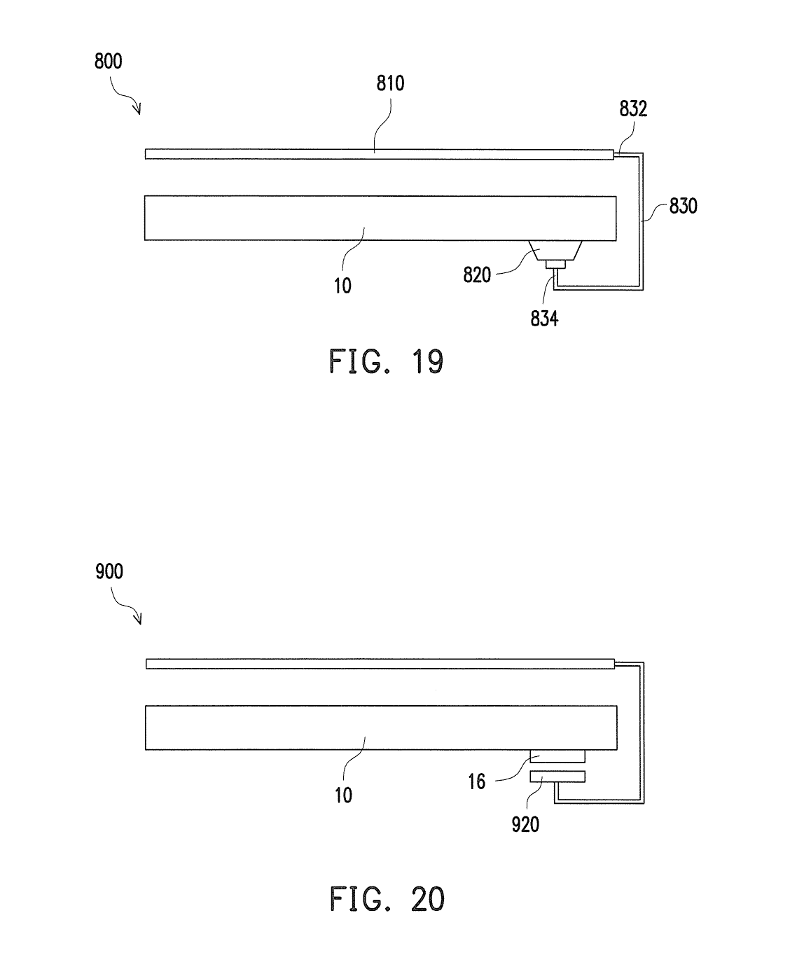

FIG. 19 is a schematic view of a display magnifying device according to another embodiment of the disclosure. Referring to FIG. 19, a display magnifying device 800 of the present embodiment includes a magnifying glass 810, an attaching member 820, and a stand 830. The attaching member 820 is detachably fixed to the electronic device 10. In the present embodiment, the attaching member 820 is a suction pad, but a type of the attaching member 820 is not limited thereto. The stand 830 has a first end 832 connected to the magnifying glass 810 and a second end 834 connected to the attaching member 820. The display magnifying device 800 is adapted to be detachably assembled to the electronic device 10 by the attaching member 820.

As shown in FIG. 19, in the present embodiment, the magnifying glass 810 and the attaching member 820 are located at two opposite sides of the electronic device 10, respectively. In other words, the attaching member 820 is attached on a back side of the electronic device 10. However, in other embodiments, the magnifying glass 810 and the attaching member 820 may also be located at the same surface of the electronic device 10, but a position of the magnifying glass 810 relative to the attaching member 820 is not limited thereto.

FIG. 20 is a schematic view of a display magnifying device according to another embodiment of the disclosure. Referring to FIG. 20, a major difference between a display magnifying device 900 of the present embodiment and the display magnifying device 800 of the previous embodiment is that, in the present embodiment, the electronic device 10 includes a first connecting member 16, and the display magnifying device 900 includes a second connecting member 920 corresponding to the first connecting member 16. The display magnifying device 900 is adapted to be assembled to the electronic device 10 by detachably fixing the second connecting member 920 to the first connecting member 16. In the present embodiment, the first connecting member 16 and the second connecting member 920 are two magnetic units attracting each other. However, in other embodiments, the third connecting member 16 and the fourth connecting member 920 may also be two corresponding buckling units, two corresponding locking units, or two corresponding bonding units. Nevertheless, types of the first connecting member 16 and the second connecting member 920, and positions for them to be disposed on the electronic device 10 are not limited to the above.

In summary, the display magnifying device of the disclosure is capable of providing an image magnifying effect through the magnifying glass disposed on the display of the electronic device. Also, the display magnifying device may be stably fixed to the electronic device by connecting the plug to the external socket of the electronic device, or by covering at least a part of the electronic device with the casing, so that it can be used and carried around easily.

Although the disclosure has been described with reference to the embodiments thereof, it will be apparent to one of the ordinary skills in the art that modifications to the described embodiments may be made without departing from the spirit of the disclosure. Accordingly, the scope of the disclosure will be defined by the attached claims not by the above detailed description.

What is claimed is:

1. A display magnifying device, adapted for an electronic device having an external socket, and the display magnifying device comprising:
a magnifying glass;
a plug fitting the external socket, wherein the plug comprises an audio terminal, a micro USB terminal, a mini HDMI terminal, a micro HDMI terminal, a power supply terminal, or a Lightning terminal;
an auxiliary member disposed on one side of the plug, and the auxiliary member contacting a surface of the electronic device when the plug of the display magnifying device is plugged in the external socket of the electronic device; and
a stand having a first end connected to the magnifying glass and a second end connected to the plug, and the magnifying glass being adapted to be detachably assembled to the electronic device by connecting the plug to the external socket.

2. The display magnifying device of claim 1, further comprising a holder connected to the first end of the stand and adapted to hold an edge of the magnifying glass, and the stand being connected to the magnifying glass by the holder.

3. The display magnifying device of claim 1, further comprising a first connecting member and a second connecting member fitting each other, the first connecting member being disposed on the magnifying glass, and the second connecting member being disposed on the stand.

4. The display magnifying device of claim 1, wherein the stand and the magnifying glass are integrated as one.

5. The display magnifying device of claim 1, wherein the stand is a flexible stand or a telescopic stand.

6. The display magnifying device of claim 1, wherein a pattern is coated or printed on the plug.

7. The display magnifying device of claim 1, wherein the plug has two sets of terminals with different specifications.

8. A display magnifying device, adapted for an electronic device, and the display magnifying device comprising:
a magnifying glass;
a casing adapted to at least cover a part of the electronic device; and
a stand having a first end connected to the magnifying glass and a second end connected to the casing, and the display magnifying device being adapted to be detachably assembled to the electronic device by covering the part of the electronic device with the casing.

9. The display magnifying device of claim 8, further comprising a holder connected to the first end of the stand and adapted to hold an edge of the magnifying glass, and the stand being connected to the magnifying glass by the holder.

10. The display magnifying device of claim 8, further comprising a first connecting member and a second connecting member fitting each other, the first connecting member being disposed on the magnifying glass, and the second connecting member being disposed on the stand.

11. The display magnifying device of claim 8, wherein the stand and the magnifying glass are integrated as one.

12. The display magnifying device of claim 8, wherein the stand is a flexible stand or a telescopic stand.

13. The display magnifying device of claim 8, further comprising a holder connected to the second end of the stand and adapted to hold an edge of the casing, and the stand being connected to the casing by the holder.

14. The display magnifying device of claim 8, further comprising a third connecting member and a fourth connecting member fitting each other, the third connecting member being disposed on the stand, and the fourth connecting member being disposed on the casing.

15. The display magnifying device of claim 14, wherein the third connecting member has a strap hole.

16. A display magnifying device, adapted for an electronic device, and the display magnifying device comprising:
a magnifying glass;
an attaching member detachably fixed to the electronic device; and
a stand having a first end connected to the magnifying glass and a second end connected to the attaching member, and the magnifying glass being adapted to be detachably assembled to the electronic device by the attaching member.

17. A display magnifying device, adapted for an electronic device, wherein the electronic device comprises first connecting member, and the display magnifying device comprises:
a magnifying glass;
a second connecting member detachably fixed to the first connecting member; and
a stand having a first end connected to the magnifying glass and a second end connected to the second connecting member, and the display magnifying device being adapted to be assembled to the electronic device by detachably fixing the second connecting member to the first connecting member.
